(19) United States
(12) Patent Application Publication
(10) Pub. No.: US 2023/0380599 A1
(43) Pub. Date: Nov. 30, 2023

(54) Foot Pillow

(71) Applicant: David Grant Miller, Eureka, CA (US)

(72) Inventor: David Grant Miller, Eureka, CA (US)

(21) Appl. No.: 17/804,145

(22) Filed: May 26, 2022

(51) Int. Cl. A47C 20/00; A47C 21/04

(52) U.S. Cl. CPC A47C 20/021; A47C 21/048

(57) ABSTRACT

A framework spanning the lower end of a mattress and positioned to use overlying bedding materials for creation of an enclosed open space on the upper surface of the mattress for the free movement of feet and lower limbs of humans. The controlled environment within this space provides ample surface area to allow healthful movement of air currents, heat and humidity and thus enable unrestrained natural radiation of body heat through the feet of sleeper(s) encouraging the beneficial outcomes of nocturnal circadian rhythms. With comfort and convenience as high priorities, this bedding accessory is designed for long-term use in therapeutic and household settings.

### CROSS-REFERENCE TO RELATED APPLICATIONS

This application claims the benefit of provisional patent application Ser. No. 63/259,163 filed Jun. 23, 2021 by the present inventor.

### BACKGROUND

A good night's sleep is important for living a happy productive life, and providing a good environment for your resting body and your resting feet should be primary considerations. Our feet, unlike other human limbs and features which roll easily to assume various resting positions, are hinged perpendicular to the body axis. Feet are also highly complex features, containing 26 bones each, 33 joints and more than 120 muscles, ligaments and nerves. Their special construction and biological complexities deserve some additional consideration.

Therapeutic Need

Unfortunately, little has been done to accommodate the feet of someone resting and sleeping in the mode of today. Freedom of movement and an open-air environment, characteristics of a comfortable and healthy resting place for our feet, are not available options. Sleeping with our feet bearing the weight of, constrained by the friction of, in constant contact and in close association with overlying bedding materials is the norm.

Loss of mobility and foot pain due primarily to gout, peripheral neuropathy and peripheral arterial disease are major areas of disability in senior citizen populations around the globe. In the USA one in three people over age 65 suffers from foot pain, stiffness or aching feet. Therapeutic applications, particularly those directed toward long-term care settings appear to be ineffective in relieving symptoms and returning the afflicted to normal ability levels.

Circadian Rhythm and Thermal Environment

Scientific study of the effects that circadian rhythms have on human sleep has revealed the importance of internal temperature modulation and points to the need for a healthy thermal environment in which to place our feet during periods of sleep. Release of excess body heat that builds up during the day is a vital function carried out primarily by the hands and feet during nocturnal sleep.

In the field of Physiology a growing body of research relates human health to existing thermal conditions during sleep, conditions which may limit transpiration of heat and humidity and thus be deleterious to vital periods of deep sleep. To quote the Mizuno study listed below, “The thermal environment is one of the most important factors that can affect human sleep.”

Recent studies include: Effects of Thermal Environment on Sleep and Circadian Rhythm; authored by Kazue Okamoto-Mizuno and Koh Mizuno, published in the Journal of Physiological Anthropology, 2012. Mechanisms and Coupling between Sleep and Temperature Rhythms; authored by Eus J. W. Van Sumeren, published in Progress in Brain Research, 2006. Research on these topics has been ongoing for decades and results consistently show a linkage between the nocturnal release of body heat from distal areas of the body (hands and feet) and human health.

### PRIOR ART

Prior patent art reveals many efforts in the areas of therapeutic amelioration and to enable medical procedures involving the feet. No advances in modern sleep arrangements were identified that provide long-term therapeutic relief for the feet of sleepers or any similar improvement to benefit household resting/sleeping conditions.

A Spanish patent ES1142641U was issued in 2015 to Arturo Gomez Cores, “Coupling structure foot type for elevation of bed clothing in the lower limb”. This is a temporary rigid structure, not adjustable and separate from routine bedding functions.

U.S. Pat. No. 2,437,016 issued in 1948 to H. E. Christensen, “Therapeutic Device”. This is a cage-type structure placed on the mattress over the feet (uncovered by bedding), and appears to be basically a base of attachment for lighting/heating fixtures.

U.S. Pat. No. 1,564,596A issued in 1925 to H. Lo Grasso, “Orthopedic Bed”. This is a multi-segmented metal frame underlying a mattress which will allow for raising and lowering at various points, and is a specialized device for medical treatment.

U.S. Pat. No. 3,571,828A issued in 1971 to Delton E Bergsgaard, “Foot Rest Device”. This is a medical appliance that would support a patient's foot above the mattress and provides a temporary respite and not a long-term environment.

U.S. Pat. No. 4,686,727A issued in 1987 to Lawrence H. Wilkinson, “Convenience bar assembly for hospital bed”. This rigidly attached support structure holds up a horizontal bar that spans the bed side-to-side, allowing a patient to grasp a dangling handhold and pull to a seated position.

U.S. Pat. No. 3,713,182 issued in 1973 to Hugh E. McNeal, “Bedclothes Elevator and Bed Warmer”. This is similar to U.S. Pat. No. 2,437,016/Christensen listed above, but with an air blower instead of heat lamps; a temporary frame for supporting bedclothes with wiring and ducting.

U.S. Pat. No. 3,317,932 issued in 1966 to M. J. Gibbons, “Bedclothes Support”. This device is another temporary framework extending partially across the mattress foot held by various braces and rollers presumably for an immobilized patient.

U.S. Pat. No. 5,329,658 issued in 1994 to Marie Fontenot, “Blanket Elevator Apparatus”. A similar device as those above, also temporary and therapeutic in nature, which includes a sheet pinching outer frame.

U.S. Pat. No. 6,901,616 B1 issued in 2005 to Scott C. Warrington, “Blanket Support Assembly”. A tubular frame with telescoping sides that can be folded over the foot of a mattress. This appears an easier and more practical method than many others, but is still a temporary mechanism and focused on therapeutic application.

Many other prior art examples could be listed here and perhaps many are useful devices, but this presenter is struck by the impression that the main body of this work is gadgetry, with specific and therefore a limited field of application.

Conclusions

The current device has the potential for introducing a sea change to our concept of therapeutic and domestic bedding: A convenient enclosure that provides our feet with every comfort and fits within the form and functions of current bedding designs. An open zone of controlled thermal conditions which is in conformance with environmental and biological factors associated with human health and happiness.

Based on this presenter's review, prior patent art in this area appears to vary widely from the current effort. The present device emphasizes flexibility and ease of adjustment, so that a Foot Pillow may integrate with any mattress and adjust to any scenario involving the feet and lower limbs of one or more sleepers. This flexibility and the many advantages of suspended bedding over an open area for the free movement of feet and lower limbs distinguish this concept from previous work. This device adds not only to the pleasure of sleep, either at home or in a therapeutic setting, but will also maximize deep sleep health benefits identified by circadian rhythm science.

Therapeutic use of the Foot Pillow in long-term care institutions and in-home health care sites would improve the care standards currently available at those facilities. Additionally, this device is seen as a bedding accessory for the improvement of sleeping conditions in the home. As such (and unlike the cited prior patent art) the Foot Pillow is designed for long-term use, will easily integrate into the form and function of daily life, and will be suitable for a wide range of modern bedding options.

### SUMMARY

The Foot Pillow (A) is introduced here as a bedding accessory, but this alteration to the standard bedding environment is so transformative that it really amounts to a change in lifestyle. A Foot Pillow puts our feet first, and that is what science and the woeful state of foot ailments in this country and around the world are telling us to do.

The open environment created by the Foot Pillow frame provides ample room for the comfort and movement of our feet while at the same time accommodating transpiration of heat and humidity. Simple bedding options regulate the flow of air and warmth within this controlled open space, providing a buffer against rising and falling temperatures. A gentle amount of supplemental thermostat-controlled heat is available at the touch of a button.

Management of daily bedding duties and laundering is unhindered by this new accessory due to a design that is streamlined and easy to work around. The Foot Pillow framework is both flexible and stable in place, adjustable to any mattress width, any foot size or height of user, and can be used by one or two occupants.

The Foot Pillow is also a harbinger of good health. It is the only device to provide an ideal setting for the release of excess body heat during periods of nocturnal sleep. This biological requirement, which is carried out mainly by our feet, is central to the fulfillment of nightly circadian rhythms linked to cycles of deep sleep which are vital to human health.

In summer or winter, spring or fall the Foot Pillow is a new frontier for the comfort, freedom of movement, and good health of our feet and lower legs. With only a few simple seasonal adjustments this new bedding accessory is a gateway to year-around sound sleeping.

### SPECIFICATION

The title of this new device uses the active form of the word pillow, meaning literally to put an object at rest. The controlled space within the framework of the Foot Pillow (A), the Foot Pillow Zone (H), provides an open area for the free movement of a sleeper's feet and lower legs. This freedom of movement is experienced either side-to-side (as a pendulum), or as a sleeper is rolling or turning.

A healthful flow of air is generated inside the Zone by a sleeper's body heat and the extensive surface area within assures the smooth passage of heat and humidity through overlying bedding. The buffering effects of insulation, adjustments of overlying bedding and supplemental heating (when appropriate) protect the sleeper's feet against significant rising or falling temperatures within the Zone.

The combination of these effects—an open airy environment and a moderated temperature regimen—when used in tandem with a comfortable mattress is deserving of the moniker Foot Pillow.

Prelude

The writer admits to a degree of redundancy in making a full disclosure of the novelty and usefulness of this new device. The hoped-for audience will likely have a wide range of perspectives, and in attempting to provide a common canvas some major points and themes have been re-visited. For this writer, the broad spectrum of scientific applications and the very real biological implications that are bound tightly to this project have held sway.

### DESCRIPTION

The following details pertain to the Prototype 2 model of the Foot Pillow (A) that has been in daily use for over one year. The previous Prototype 1 was used for about one month. The materials used were primarily those on hand, and since this period of development has been highly experimental, there was an effort to avoid costly alterations. This embodiment is installed on a standard-sized queen mattress (8) and box spring, all of which fit into a wooden frame with headboard and footboard; the set is typical of a commercial queen-sized bed.

Foot Pillow Framework

In this instance the base of connection and primary stability is made using tube inserts (6) comprised of Schedule 40 PVC (all PVC parts are one-half inch Inside Diameter (ID) Schedule 40) which, along with the tube insert braces (7), made from pine wood and wrapped with duct tape, are placed between the mattress (8) and box spring near the foot of the mattress. Note that even with these insert assemblies in place, a mattress cover pad and top sheet can be readily applied or removed.

This embodiment has two strut base tubes (5) of PVC on each side which connect orthogonally to the tube inserts using one-half inch PVC elbows. The tops of the strut base tubes are fitted slidably with strut length adjusters (4) comprised of one-half inch diameter wooden dowels. The tops of these strut length adjusters then fit slidably into the heat-molded PVC hip sections (2) of the horizontal assembly that spans the mattress. The operating height of the Foot Pillow framework can then be adjusted and locked in place by the use of set screws (3), a pair of which is located on each strut assembly at either ends of the strut length adjusters.

The single control bar (1) that characterizes this embodiment extends across the mattress, connecting the two pairs of hip sections. This control bar is a one-piece section constructed of two one-half inch ID fiberglass wound epoxy tubes, the edges of which fit the concave sides of a pine wood core that is sandwiched between them. Duct tape wrapping secures the control bar components. Wooden dowel pieces inserted into each end of the epoxy tubes and then into the upper ends of the hip sections serve as connectors and are held in place by friction.

Supplemental Heat System

The primary source of Foot Pillow (A) warmth is a sleeper's own body heat, but there are times—initial entry into the bed and cool early morning hours—when supplemental heating may be useful. Since the Foot Pillow Zone (H) is an enclosed air space, a convenient thermostatic heating system can be installed and efficiently operated.

In the current embodiment this system consists of a digital thermostat (11) that is attached on the lower ends of a pair of hip sections (2) and resides underneath the overlying bedding. The 120-volt thermostat (typically used in a terrarium or reptile enclosure) is adjustable by each degree Fahrenheit and is regulated within a two-degree range by a heat sensor (10). These components operate a twenty-watt heat mat (12), which is typically used for seed germination and measures 10×20 inches.

Many experimental heat application set-ups were tried prior to arriving at the current arrangement, which has the heat mat balanced over the control bar (1) lengthwise and lying atop the tension skirting (9) at a point near the opposite end from the heat sensor. Cotton toweling, glued to one side of the heat mat for texture purposes has been used as a means to attach the mat by staples to the pine wood core of the control bar.

This system works well and it is anticipated that a future manufactured embodiment would be consistent in positioning the heat source to avoid direct contact with the feet and lower leg and emphasizing low power output (wattage) of the source. A future control bar embodiment would be self-contained for electrical connections between thermostat, temperature sensor and heat source. The chosen heat source would be moveable (by segmentation or other means) along the control bar to match various scenarios—optional sizes of mattress, number of sleepers, arrangement of overlying bedding, etc.

Tension Skirting

As a method of bracing the Foot Pillow (A) framework against strains created by the foot movement of sleepers, daily activities of making the bed, adjustment of bedding materials or changing/laundering, a piece of sheeting material has been used to create a “shock absorber”. This tension skirting (9), referred to in the above section, is comprised of a folded cotton sheet one edge of which has been attached by staples along the length of the pine wood core of the control bar (1). The remaining material is wrapped around the control bar (covering the staples), and then extends over the foot end of the mattress (8) and is tucked in between the mattress and box spring.

This innovation has worked very well in stabilizing and really solidifying the Foot Pillow framework. The moderate tension of the sheet is enough to offset the strain of bedding pulled toward the head of the bed when using the bed and in making up the bed. This offset is total, so that the making of the bed is actually less of a chore than with a standard bedding arrangement. Despite the greatly increased feet and lower leg movement that is inherent when using this new bedding accessory, the Foot Pillow framework is not affected, and the angle of the bedding hanging over the framework is sharp enough that the bedding does not shift noticeably.

In addition to the stability and convenience that the tension skirting has added, it has also improved the overall appearance of the Foot Pillow profile by rounding out the rear edging and clearly defining a flat slope from the control bar to the foot of the mattress. One other aspect that should be noted is that the tension skirting is now the inner surface of the back wall of the Foot Pillow Zone (H), so a sleeper's feet may contact the skirting.

Operation

A major focus in the development of the Foot Pillow (A) has been to minimize disruption and inconvenience when it comes to everyday use and maintenance. Ingress and egress are unaffected so long as a sleeper is able to bend his/her knees. The transition into the Foot Pillow equipped bed is a bit of a two-step process due to the noticeable division between the torso area (G) (shoulders to knees) and everything below the knees.

Heat Circulation

Once established in bed and once the sheets and bedding materials in the torso area begin to warm up (a process of a few seconds) body heat, primarily from the torso area, begins to move into the Foot Pillow Zone (H). This natural movement of heat along and between the legs, termed the Thermal Shift (see Diagram 1), is encouraged by the immediate proximity and elevation of the Zone and is the single largest source of overall heat for the Zone.

The Thermal Shift can be regulated by bedding changes made in the torso area. An added blanket (or a removed one) will alter the rate of heat retention in the torso area and likewise affect the level of heat movement associated with the Thermal Shift.

Note that in this system body heat is the only source of heat, and that this heat will always dissipate through the bedding; we can only minimize or increase the rate of heat loss. Note also the importance of that dissipation: the greatly expanded surface area of the Foot Pillow Zone (as compared to traditional bedding) provides an essentially unlimited setting for heat, humidity and air to circulate and dissipate; processes that are crucial to the health and vitality of human sleep. The sum of these environmental factors directly affects important biological functions that have been identified through circadian rhythm research.

Heat Loss Equilibrium

Experimentation has shown that a close equilibrium of heat loss rates between the torso area (G) and the Foot Pillow Zone (H) can be reached by a doubling of the bedding over the Zone as compared to the torso area. An example of this insulating layer, termed equilibrium bedding (D), is illustrated in Diagram 1. This method of equalizing heat loss is helpful in maximizing (and regulating) the level of warmth produced from the Thermal Shift during cool weather times and likewise relieving excess heat during warm times.

The advantages of this approach are significant. During the cool/cold seasons, when the warming capacity (and buffering effects—see below) of the Thermal Shift are overwhelmed, a sleeper(s) need only turn on the thermostat-controlled supplemental heat system—which will only become active if the Foot Pillow Zone temperature falls below a desired level.

In warm/hot conditions the system works even better. With reduced torso bedding, minimal Thermal Shift and low bedding over the Zone, sleeper(s) get the full benefit of the open and airy conditions of the Foot Pillow. In warm sleeping conditions the biggest sources of discomfort are direct and close contact of bedding on your feet and lower legs. When sleeping with a Foot Pillow those sources are gone!

Note that this discussion addresses only the comfort and convenience advantages of the Foot Pillow. In these same warm/hot sleeping conditions the biggest threat to healthy sleep cycles is humid heat (see discussion below), particularly when the soles of a sleeper's feet are exposed to humid heat.

Buffering Effects

The combination of the above-described conditions—a regulated Thermal Shift and an insulated Foot Pillow (A) (to achieve heat loss equilibrium between the torso area (G) and the Foot Pillow Zone (H))—creates a buffering effect within the Zone. This buffering effect is noticeable in reducing changes in temperature either higher or lower. As indicated above, buffering is magnified under warm/hot conditions due to the separation of bedding materials from a sleeper's feet and constant air circulation within the Zone.

Throughout this experimental and testing period a daily notebook has been kept. Dozens of entries refer to nights when this buffering effect was noticeable. In many of those instances bedding modifications were made to adjust for comfort in the torso area (either chilled or too warm), but in no cases did the Foot Pillow Zone require modification (other than the choice to switch on the supplemental heat system).

Making basic adjustments to the Foot Pillow for seasonal cooling and warming as described above is the only requirement to improve year-around sleeping comfort for sleeper(s) feet and lower legs.

A Last Note on Heating

In addition to the usual approach of turning on a heat source only when needed, having a thermostat (11) control system gives users much more flexibility. A sleeper need only anticipate a possible chill (say, at 4 am) to turn on the system which will remain essentially on stand-by until the sleeper's desired minimum temperature is reached. This allows for uninterrupted sleep within the comfort range determined by the Thermal Shift/bedding material choices/Foot Pillow insulation level/buffering range, and then, only if needed, the sleeper's own pre-set temperature range as selected on the thermostat.

This presenter has experienced numerous nights with the scenario above and on many of those occasions the supplemental heat system was rarely (if ever) activated. On cold nights, however, in an un-heated room the supplemental system was often relied upon. On all of these occasions the Foot Pillow performed very well—even at times when additional bedding was needed in the torso area—and the most pleasant nights of sleep were the coldest!

Physiological Considerations

Circadian rhythms are 24-hour sleep/wake cycles and several of these autonomous cycles affect humans as they approach a period of nocturnal sleep and as they proceed through nocturnal sleep phases. Human health is directly related to the frequency and duration of deep sleep phases achieved during nocturnal sleep.

Environmental conditions within the Foot Pillow Zone (H) provide optimum conditions to realize circadian rhythm-related health benefits. The following is a synopsis on this subject and several references (out of many) have been listed in the Background section of this document. An additional reference by a top researcher which touches on these points is: The Interrelationship Between Sleep Regulation and Thermoregulation, American Physiological Society, 2021, by Kurt Krauchi and Tom Deboer.

High core body temperature in humans is achieved during waking hours as a result of heat production related to metabolic processes. A nightly circadian rhythm acts to decrease this core body temperature and is a vital function mainly accomplished by heat radiation/convection in peripheral skin areas.

This circadian rhythm is controlled by the hypothalamus region of the brain. The process runs for about seven hours every night and begins as we approach our normal time of nocturnal sleep. Internal heat begins to dissipate as blood flow is increased and brought close to the surface of the skin.

Specialized areas of tissue, glabrous skin (non-hair bearing skin of the lips, hands and feet) are the primary regions of heat loss. High rates of heat loss in these areas are due to the abundance of specialized blood vessels (found mainly in palms of hands and soles of feet) called arteriovenous anastomoses which bypass capillary circulation and flow directly from arterial to venous networks. Krauchi (see above) estimates this flow differential at 10,000 to 1, accounting for the increase in nightly blood circulation (2-3 times the usual resting rate) and the rapid initial core body temperature drop.

Once sleep is achieved the circadian rhythm continues and the heat releasing processes intensify due to the addition of melatonin secreted by the pineal gland. Core blood temperature drops about two degrees Fahrenheit during this cycle of events.

Throughout these processes the most capable radiators of excess core body heat are the soles of our feet. If the release of core body heat (and related humidity) during these nightly circadian rhythm cycles is limited due to environmental factors, research has shown that crucial periods of deep sleep—Rapid Eye Movement and Slow Wave Sleep—can be shortened or lost.

The Foot Pillow Zone—an expansive, open area designed for the free movement of air, heat and humidity—will provide sleepers an ideal setting for maximizing health benefits linked to our own biology and the power of circadian rhythms. In this important respect, the Foot Pillow stands in stark contrast to the standard bedding available today.

The Gentle Good Night

By integrating the novel improvements of the Foot Pillow (A) into a nightly routine, sleepers will benefit both in overall quality of sleep and in the frequency and duration of the most beneficial (deep) periods of sleep. A good night's sleep may be elusive for a variety of reasons and this discussion will address only those aspects affected by the present device. A primary basis for this rationale is taken from numerous studies using encephalograph records of brainwaves in various stages of wakefulness and sleep.

Differentiation of brainwaves and patterns of wave-like activity have long been established as an accurate methodology for identifying and dividing periods of wakefulness and sleep. Waking brainwave patterns fall into two classes—wide awake and tired awake. Sleep waves are divided into four classes—N1, N2, N3 (slow-wave sleep), and REM (Rapid Eye Movement sleep). Interestingly, wide wakefulness and deepest sleep (REM) brainwaves are identical.

Sleep is a semi-autonomous condition, a state encouraged by placing oneself in a restful setting and generally in a prone position. Cycles of circadian rhythms, however, are completely autonomous. So in this case a sequence of autonomous nightly events directs blood flow from the core of the body to peripheral areas of glabrous skin where the blood is exposed to a cooler environment. It is in the marriage of these two processes—sleep and circadian rhythm—that the Foot Pillow delivers significant health and restfulness benefits to sleepers.

Brainwave studies correlated with the nightly drop in core body temperature show a consistent relationship between lowered core temperatures and increasing total time spent in deep sleep cycles(slow-wave and REM), both in terms of frequency and duration. Deep sleep cycles are a basic biological requirement for humans and are closely tied to overall health.

The controlled environment within the Foot Pillow framework, the Foot Pillow Zone (H), provides an ideal setting for radiation and convection of body heat. Note that in any reclining posture—on your back, on your side, or on your chest—the heat radiating surface of the soles of your feet are completely exposed. So the soles of our feet, the largest areas of glabrous skin that we have, are freely exposed within the Foot Pillow Zone thus maximizing our ability to vent heat. At the same time the Foot Pillow also maximizes the immediate dilution of that heat (and related humidity), while providing easy passage of heat and gases alike through an expansive surface area and an elevated profile.

### DRAWINGS—FIGURES AND DIAGRAM

In the drawings below, numerical identities for parts are consistent on FIGS. 1, 2 and 3. Diagram 1 is more conceptual in nature and where overlap of alphabetical labels and numerical parts has occurred those overlaps are identified in the Key provided.

FIG. 1 shows a perspective view of the Prototype 2 Foot Pillow framework with no attachments, positioned for use in a mattress/box spring setting.

FIG. 2 shows a side-view of the Foot Pillow framework from the foot area of a mattress with tension skirting in place.

FIG. 3 is a perspective view from below mattress level of the Foot Pillow framework with heating system components and tension skirting.

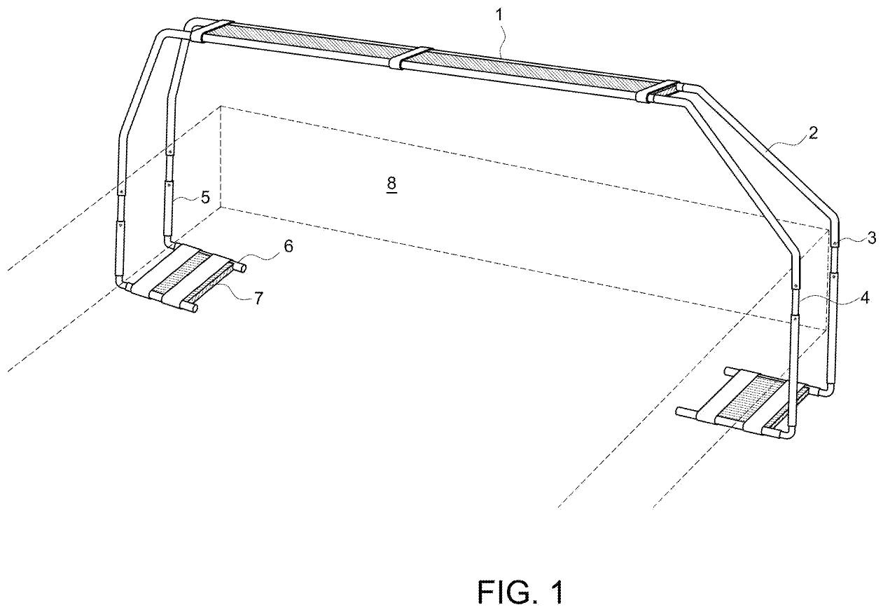

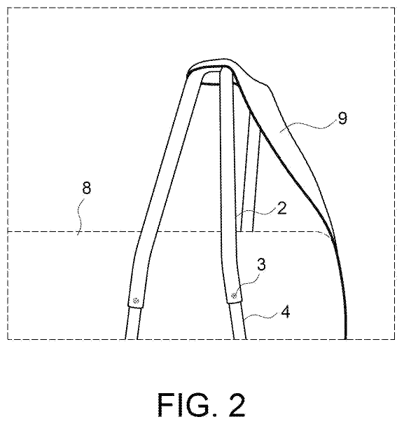

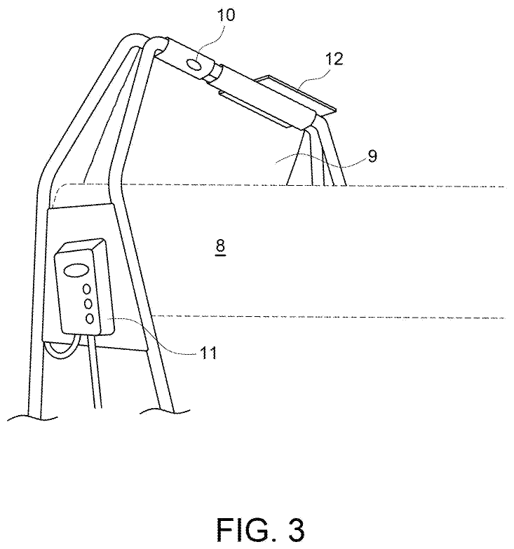

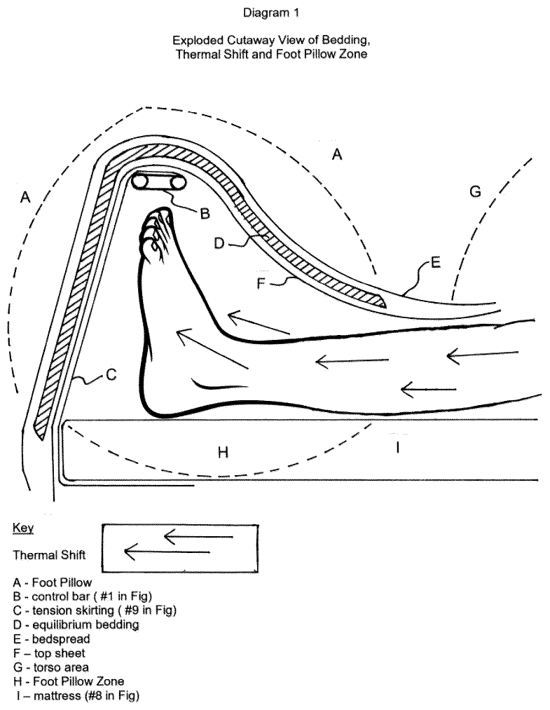

Diagram 1 presents a diorama bringing together several novel aspects of the Foot Pillow Zone environment and a visualization of the Prototype 2 embodiment.

### FIGURES—REFERENCE NUMERALS

1 control bar
2 hip section
3 set screw
4 strut length adjuster
5 strut base tube
6 tube insert
7 tube insert brace
8 mattress
9 tension skirting
10 heat sensor
11 thermostat
12 heat mat

### CONCLUSIONS

Introduced as an accessory for therapeutic applications and modern bed sets, the Foot Pillow (A) aligns to the structural and physiological needs of our feet and revitalizes the sleep experience. The reader will see that the described prototype greatly improves the resting environment for a user's feet by several metrics. Free from the constraints of bedding materials and free to move about in a climate-controlled setting, a user's feet and lower legs are exposed only to a gentle flow of air currents and are protected against the discomfort of high or low temperatures.

Providing convenience as well as comfort, the Foot Pillow may be combined with any mattress configuration and will adjust to persons of any foot size or length of limb.

Normal daily use, daily upkeep and periodic laundering activities are accommodated and unhindered.

Many physiological processes take place while we sleep. None of these is more important than the release of excess heat that builds up in the body each day. The soles of our feet are the biggest radiators of this heat, and the Foot Pillow provides an ideal setting for this process. As the only device conforming to circadian rhythm biology, the Foot Pillow stands alone as an encouraging environment for rest and health.

### RAMIFICATIONS

The focus of this presentation is the second prototype of the Foot Pillow which has undergone dozens of modifications and upgrades since its inception. Several thousand hours of actual usage and testing have been applied to date. The current result is a device that will greatly benefit the sleeping environment that we know today.

Transforming this device into a finished product and adapting it to the myriad of settings in which to benefit will be challenging. The following discussion will attempt to generally describe this anticipated transition to the marketplace. None of this should be construed as limitations on the scope, but rather as a broad exemplification of the many embodiment(s) that this device will become. Accordingly, the scope of this disclosure should not be determined by the fundamental form of the described prototype, but by the appended claims and their legal equivalents.

A manufactured version of the Foot Pillow for therapeutic or general use would require many upgrades in materials and construction over the described prototype embodiment:

Materials

Framework components in a finished product would need to meet high standards for structural durability and, as an assembled unit, exhibit a degree of flexible rigidity. These parts would be produced from raw materials accepting of a very smooth finish and be appealing to the consumer. Some examples would be tubular metal, high impact plastic, and various combinations of extruded materials, molded resin, fiberglass or some similar structurally sound material.

Horizontal members would likely be of high quality extruded plastic, possibly containing carbon fiber components for rigidity, perhaps with metallic parts, or some other hybrid of components. Any chosen material would need to be receptive to modification as multi-segmented units, be adaptive for internal electrical connections and related heating and sensor apparatus.

Connecting and Adapting

A wide range of sizes and connectors for various assemblies is envisioned. Bases for attachment and mounts for strut components would need to adapt to many bedframe and mattress models. Single component mattresses may use a system of underlying straps with ratchet adjustments for securing a mounting base for the Foot Pillow framework. Anchored or clamped bases for this purpose may be applied on framed mattress models. Inserted frameworks like the prototype detailed above may be used on mattress/box spring sets.

Different mattress widths will require a variety of horizontal member components. As a future generic example, multiple horizontal segments would be required which interconnect and whose total length spans the applicable mattress width. Each end of the assembled horizontal member(s) would then attach to strut supports on either side of the mattress. The use of multiple horizontal segments would also aid in handling, packaging and shipping considerations.

Connectors and means for adjustment of component length and relative position would be important in a manufactured product. Breakaway connectors with safety latches between horizontal segments would be one of many possible solutions. Sliding and telescopic adjustments of strut members could be accomplished by many hardware applications, such as setscrew mechanisms, various friction and pressure engagement units or threaded adjustment devices.

Electrical Wiring

A typical bedroom set-up has the foot of the bed towards the middle of the room and the headboard near the wall. Plug-in outlets are usually located in these walls, making an easy connection for any appliance associated with the Foot Pillow. The present prototype model has an in-line rocker switch attached to a small cardboard control panel which is mounted on the headboard for on/off control of the supplemental heating system. This has worked well and is very convenient. A future embodiment would likely expand this control panel to include some basic thermostat functions such as a system status indicator (off, on-standby, on-active) and the ability to toggle the desired temperature up or down. Optional appliances may include servo units for adjusting the Foot Pillow frame orientation and elevation.

A basic wiring harness would include an outlet connection, in-line controls, adequate perimeter wiring (likely clad in safety insulated coverings) for connections to a thermostat, appropriate sensors, heating units, optional outlets, etc.

Insulating Bedding

Seasonal adjustment of the equilibrium bedding (D) layers over the Foot Pillow Zone(H) are one of the few maintenance steps necessary to assure comfort year-around.

Quilted covers manufactured from breathable fabric and batting materials and based on standard patterns will be required. Patterns would be sized to fit various Foot Pillow frames that are appropriate for specific mattress dimensions.

User's preferences and in-room temperature ranges will vary so a selection of equilibrium bedding is anticipated. Typically, a set of light and medium weight bedding layers would suffice since these can be used singly or in combination. As such, a light layer would likely do for summer, the medium for spring and fall, and the total of the two for winter time. Note that the purpose of these insulating layers is to approach equilibrium of heat loss rates between the sleeper's torso area (G) and the Foot Pillow Zone (see Specification and Diagram 1). Minor adjustments—adding or taking away a light covering, use of supplemental heat—may give additional comfort.

P.S.

Ramifications in this instance can only be based on a degree of speculation. In a business sense (and the writer is not a businessman) the market will determine where this product will go. Retrofitting and retooling for every possibility—and similarly trying to anticipate every possibility in this writing—is just not practical. So please allow for the repetition and consider the request that the scope of this disclosure should not be determined by the fundamental form of the described prototype, but by the appended claims and their legal equivalents. Thank you.

What is claimed is:

1. A bedding accessory comprising:
a. a framework spanning a mattress side-to-side which suspends overlying bedding materials above one or more sets of human lower limbs,
b. said framework and suspended bedding materials forming an open space above said mattress with means for freedom of human feet movement and for control of environmental conditions within said open space.

2. A bedding accessory comprising:
a. a healthful setting within said framework and open space for the feet of humans as they approach a period of sleep and for the duration of said period of sleep,
b. resting conditions for said human feet identified by scientific research to be ideal for promoting periods of deep nocturnal sleep.

1a. The bedding accessory of claim 1 wherein said framework is adjustable to the size and position of one or more sets of human lower limbs.

1b. The bedding accessory of claim 1 wherein said framework and suspended bedding materials effectively control movement of air and heat within said open space so as to provide a buffer against rising and dropping temperatures within said open space and whereby improved conditions of temperature and humidity result.

1c. The bedding accessory of claim 1 wherein a breathable sheet of skirting may be attached along one edge to a horizontal spanning member of said framework with said skirting then directed over the top of the hindmost said horizontal spanning member and attached by various means under the foot of said mattress thus providing additional stability to said framework and offsetting pulling forces of said bedding materials toward the head of said mattress.

1d. The bedding accessory of claim 1 wherein said framework consists of one or more horizontal members of one or more segments of appropriate length(s) which are attached at each end to orthogonal members with connected vertical assemblies, each set of which are adjustable in length, allowing adaptability of said framework to various sizes of mattress, human feet and length of limb.

1e. The bedding accessory of claim 1 wherein said open space comprises dimensional proportions of sufficient means to employ one or several thermostat-controlled systems for the purpose of providing a source of radiant electrical heating within said open space.

1f. The bedding accessory of claim 1 wherein said framework includes one or more said horizontal members consisting of a plurality of said segments and having one or more said segments with the means to emit electrically-controlled heat radiation.

2a. The bedding accessory of claim 2 wherein said healthful setting relates to the control of air and thermal movement and associated passage of heat and humidity through said open space due to the expansive permeable surface area within said open space, the lining of which consists of said suspended bedding materials.

2b. The bedding accessory of claim 2 wherein said resting conditions are consistent with known circadian rhythm-related biological requirements associated with human deep sleep cycles experienced during said periods of nocturnal sleep.
